(19) United States
(12) Patent Application Publication
(10) Pub. No.: US 2003/0193503 A1
(43) Pub. Date: Oct. 16, 2003

(54) Computer animation system and method

(76) Inventors: Mark Seminatore, Issaquah, WA (US); Casey Anderson, Tukwila, WA (US); Jason Piel, Redmond, WA (US); John Piel, Duvall, WA (US); Michael Dougherty, Seattle, WA (US); Julian Love, Seattle, WA (US)

Correspondence Address: KOLISCH HARTWELL, P.C., 520 S.W. YAMHILL STREET, SUITE 200, PORTLAND, OR, 97204, US

(21) Appl. No.: 10/120,967

(22) Filed: Apr. 10, 2002

(51) Int. Cl. G06T 15/70

(52) U.S. Cl. 345/473

(57) ABSTRACT

A computer animation system, method, game, device, and storage medium are provided. The method typically includes providing a two-dimensional map of an animated object, in which the two-dimensional map includes rendering information. The method typically further includes rendering an animated object by applying, in real time, portions of a skin texture to the two dimensional map based on the rendering information. The method may be used for real-time computer game animation. The rendering information may be encoded as color values, which are transmitted by color channels.

### TECHNICAL FIELD

The present invention generally relates to computer animation, and more specifically relates to rendering objects by applying skin textures to two-dimensional maps of the objects.

### BACKGROUND OF THE INVENTION

Rendering realistic characters is a difficult problem in the field of computer animation. Some computer animation techniques rely on highly specialized and expensive graphics processing units (GPUs) to overcome this problem. However, many devices used to display computer animation do not have dedicated GPUs capable of rendering realistic characters in real time. For instance, many desktop computers, laptop computers, and mobile computing devices such as mobile phones and personal digital assistants do not include capable GPUs. GPUs may be too expensive, too large, produce too much heat, or require too much power to include in such devices. However, it is desirable to render realistic characters on such devices for use in games and other applications. Games that incorporate realistic characters provide gamers with a more enjoyable gaming experience and consequently generate favorable sales for game developers.

Game developers have attempted to provide realistic characters on devices without capable GPUs by completely pre-rendering characters on a powerful computer during game development. After the characters are pre-rendered on the game development computer, they may be stored in a user's device exactly as they will appear on a two-dimensional screen, thus obviating the need for additional computationally intensive rendering by the user's device. However, this approach requires the use of substantial amounts of memory in the user's device, because prerendered images must be stored for each character engaging in each separate activity in each separate costume. In a typical game, the character must be prerendered walking, running, jumping, sitting, standing, etc., in each of several orientations such as forward, backward, upward, downward, and diagonally, and in each of several different costumes. This requires a tremendous amount of memory.

Adding additional characters uses significant amounts of additional memory even if the character is similar to a character already loaded into memory, because new characters must be completely prerendered in each of the many activities, costumes, and orientations. Furthermore, using this prerendering method, a game developer must individually create each character and does not benefit from previous work performed while creating other similar characters. Because of the work involved in creating each character and the amount of memory each character occupies, games developed using this method are limited in the number of realistic characters that may be utilized.

It would be desirable to provide a computer animation system and method for rendering realistic characters without requiring the use of a specialized GPU or abundant amounts of memory. In addition, it would be desirable to provide a computer animation system and method that allows new characters to be easily created and displayed based on previously created characters.

### SUMMARY OF THE INVENTION

A computer animation method, system, game, device, and storage medium are provided. The method typically includes providing a two-dimensional map of an animated object, in which the two-dimensional map includes rendering information. The method typically further includes rendering an animated object by applying, in real time, portions of a skin texture to the two dimensional map based on the rendering information. The method may be used for real-time computer game animation. The rendering information may be encoded as color values, which are transmitted by color channels.

According to another aspect of the invention, a method may be provided which typically includes real-time rendering a first animated object by applying portions of a first skin texture to a two-dimensional map of the animated object. The method typically further includes reusing the two-dimensional map to real-time render a second animated object by applying portions of a second skin texture to the two-dimensional map. The two dimensional map may include rendering information used to render the first and second animated objects.

According to another aspect of the invention, a method is provided which typically includes transmitting non-color rendering information via a color channel. The non-color rendering information is typically encoded as color information. The method typically further includes rendering an animated object based on the non-color rendering information.

According to another aspect of the invention, a method for generating a two-dimensional map typically includes creating a three-dimensional model of an animated object. The method typically further includes performing a lookup render on the three-dimensional model to create a lookup model, and performing a lighting render on the three-dimensional model to create a lighting model. The lookup model and the lighting model are then combined via a combination render in order to create a three-dimensional UVLA model. A flatten render is then performed on the UVLA model to create a two-dimensional map encoded with rendering information. The method may further include performing a transparency render, which may be used in creating the UVLA model during the combination render.

The system typically includes a computer network, and at least one user computing device connectable to the computer network and configured to download, via the computer network, skin textures configured for application to a two-dimensional map of an animated object in order to render, on the user computing device, the animated object.

The computer game typically includes a two-dimensional map of at least one animated object. The two-dimensional map includes rendering information. The computer game typically further includes at least one skin texture and a rendering engine configured to render an animated object corresponding to the at least one skin texture. The animated object is typically rendered by applying the at least one skin texture to the two-dimensional map based on the rendering information.

The computing device typically includes memory configured to store (a) a two-dimensional map of an animated object, in which the map includes rendering information; (b) at least one skin texture; and (c) instructions that, when executed, result in the device having the capability of rendering the animated object by applying, in real time, portions of the at least one skin texture to the two-dimensional map based on the rendering information. The device typically further includes a processor for executing the instructions.

The storage medium typically includes instructions that, when executed, result in a computing device having the capability of loading a two-dimensional map of an animated object, in which the two-dimensional map includes rendering information. The storage medium typically further includes instructions that, when executed, result in the computing device having the capability of rendering the animated object by applying, in real time, portions of a skin texture to the two-dimensional map based on the rendering information.

### BRIEF DESCRIPTION OF THE DRAWINGS

FIG. 1 is schematic view showing a computer animation system according to one embodiment of the present invention.

FIG. 2 is a schematic diagram of a computing device of the system of FIG. 1.

FIG. 3 is schematic view of the two-dimensional map of the system of FIG. 1.

FIG. 4 is a schematic view showing a relationship between two skin textures and the two-dimensional map of FIG. 1.

FIG. 5 is a schematic view showing the application of the two skin textures of FIG. 4 to a first two-dimensional map to render two corresponding animated objects.

FIG. 6 is a schematic view showing the application of the two skin textures of FIG. 4 to a second two-dimensional map to render animated objects that each are different from the animated objects of FIG. 5.

FIG. 7 is a schematic view showing the application of a first skin texture to a collection of two-dimensional maps to render a set of animated objects.

FIG. 8 is a schematic view showing the application of a second skin texture, different from the skin texture of FIG. 7, to a collection of two-dimensional maps to render a second set of animated objects different in appearance from the set of animated objects of FIG. 7.

FIG. 9 is a schematic view of the transmission of rendering information from a two-dimensional map to a rendering engine via color channels.

FIG. 10 is schematic view showing the creation of the two-dimensional map of FIG. 1 from a three-dimensional model via a lookup render, lighting render combination render, and flatten render.

FIG. 11 is a schematic view showing the computer animation system of FIG. 1, configured for network game play.

FIG. 12 is a flowchart showing a method of rendering animated objects based on a two-dimensional map, according to one embodiment of the present invention.

FIG. 13 is a flowchart showing one exemplary method of accomplishing the step, shown in FIG. 12, of providing animated objects.

FIG. 14 is a flowchart showing one exemplary method of accomplishing the step, shown in FIG. 12, of rendering animated objects.

### DETAILED DESCRIPTION OF THE INVENTION

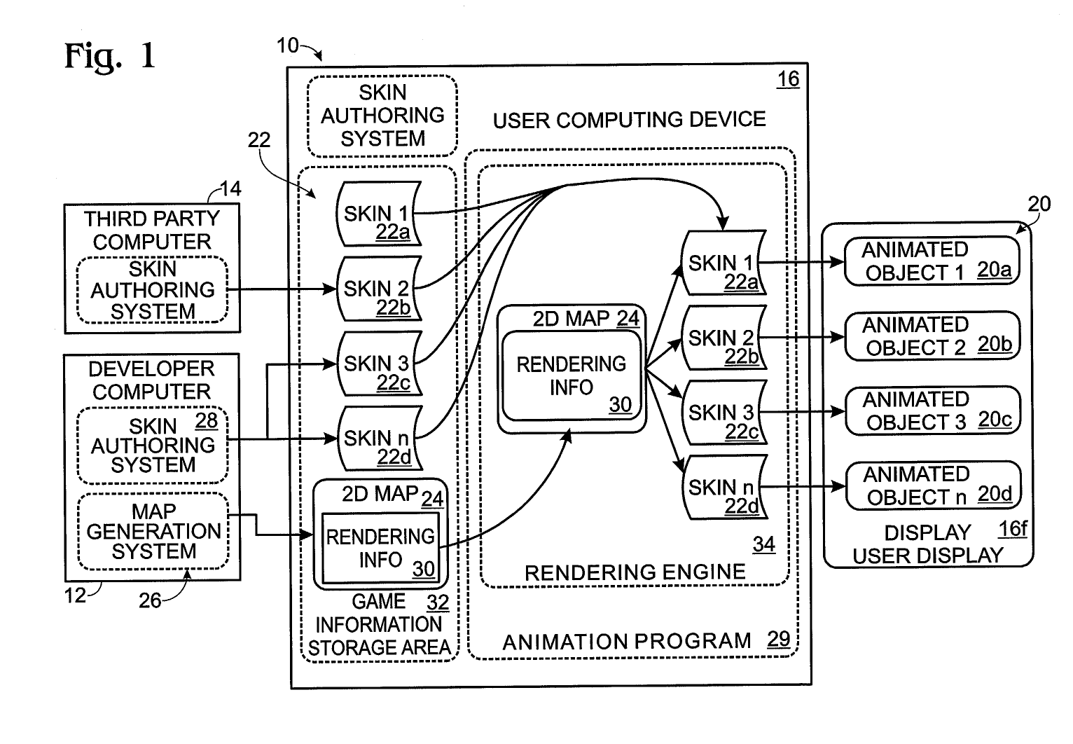

FIG. 1 shows an animation system 10 in accordance with one embodiment of the present invention. The animation system includes a developer computer 12, third party computer 14, and a user computing device 16 having an associated display 16f. Computing device 16 is configured to render animated objects 20 on display 16f by applying skin textures 22 to a two-dimensional map 24. Typically, the animated objects are characters in a computer game, although they may be virtually any animated object in virtually any animated environment. Two-dimensional map 24 is typically generated on developer computer 12 and transferred to computing device 16. Skin textures 22 are typically created on developer computer 12, third party computer 14, or user computing device 16.

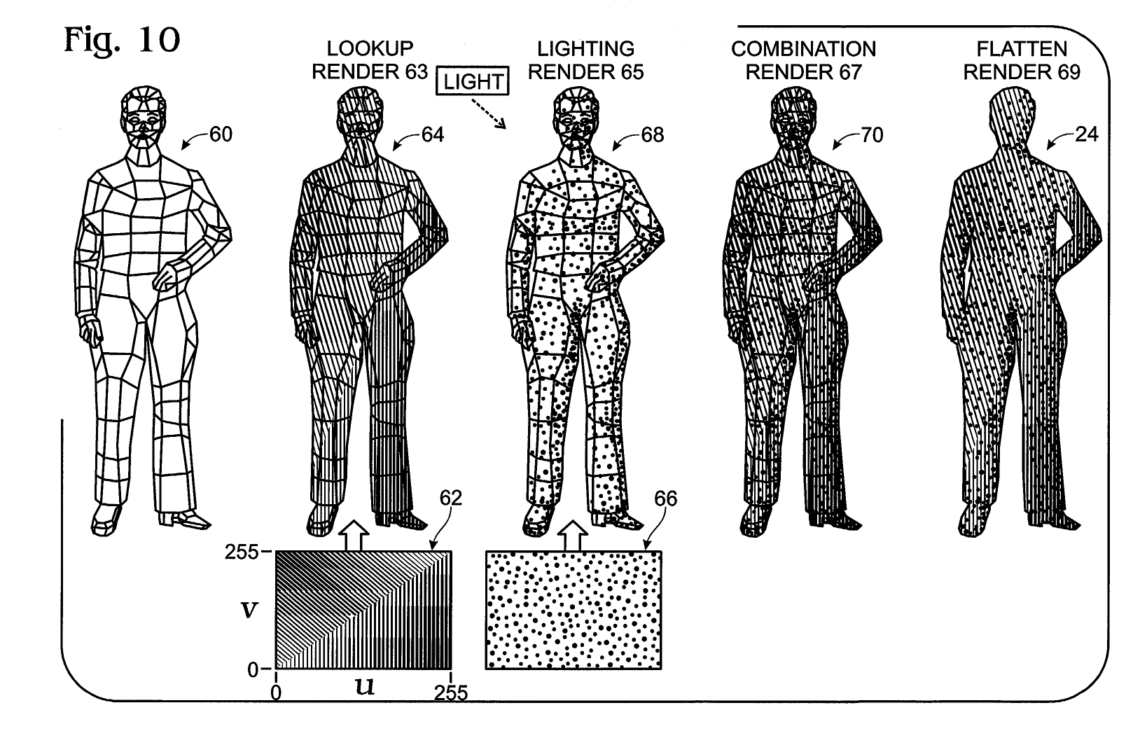

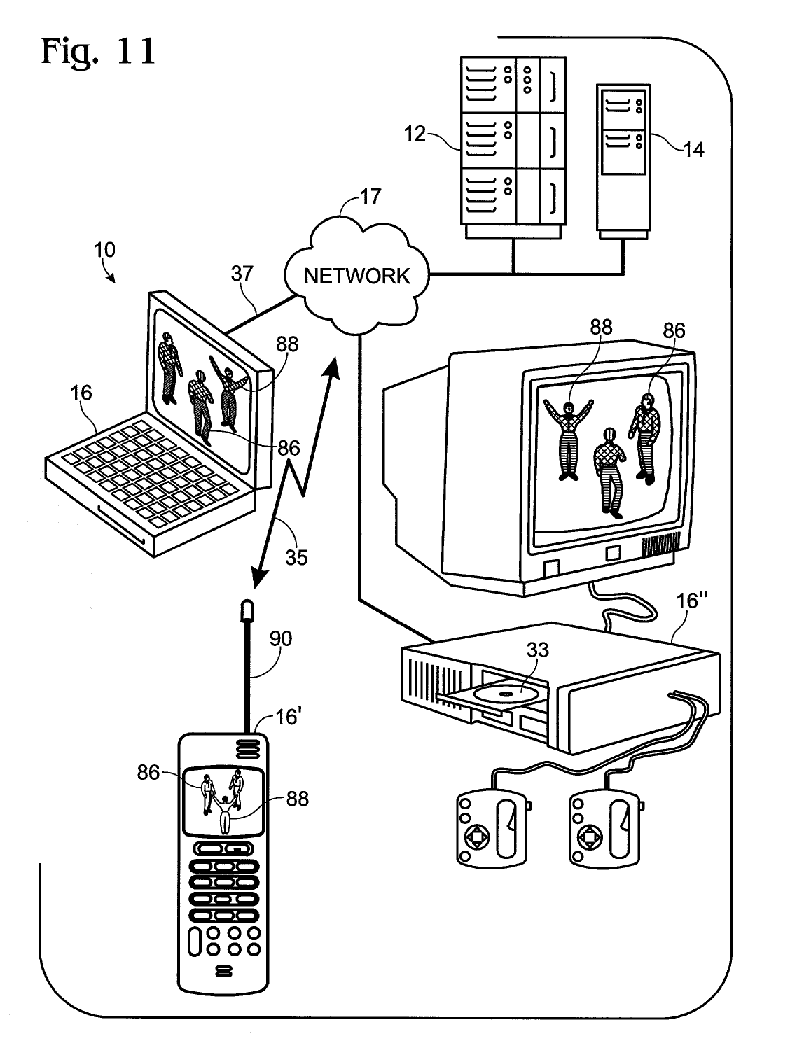

Developer computer 12 may be a personal computer, a network computer, a workstation computer, or virtually any other computing device suitable for computer animation development. Developer computer 12 typically is configured to execute a two-dimensional map generation system 26 and a skin authoring system 28. As discussed in detail below with reference to FIG. 10, two-dimensional map generation system 26 is configured to create a two-dimensional map 24 of an animated object. Two-dimensional map 24 usually includes rendering information 30, which is eventually used by user computing device 16 to render animated objects. Two-dimensional maps generated on developer computer 12 are typically configured for transfer to user computing device 16. The maps may be transferred on a storage medium 33 such as a Compact Disk (CD), a Digital Versatile Disk (DVD), a game cartridge, or other medium, as shown in FIG. 11. The maps may also be transferred via a network 17 such as the Internet as shown at 35 and 37 of FIG. 11, or by any other suitable data transfer mechanism. Maps may be transferred individually, or as part of an animation program 29 such as a computer game.

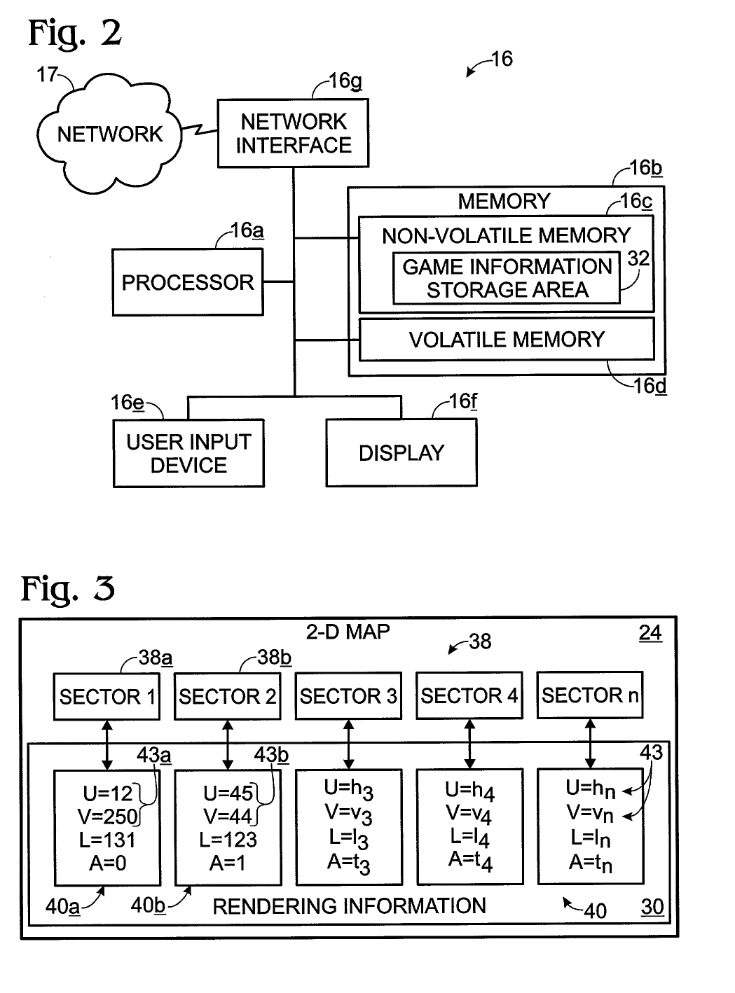

User computing device 16 is typically a personal computer such as a desktop computer or a laptop computer, a gaming console, a mobile computing device such as a mobile phone, a personal digital assistant, or a mobile gaming device, or any other device capable, alone or in conjunction with another device, of rendering animated objects in real time. As shown in FIG. 2, user computing device 16 typically includes a processor 16a coupled to memory 16b via a bus. Processor 16a is typically configured to execute programs stored in non-volatile memory 16c, using portions of volatile memory 16d. In particular, non-volatile memory 16c, typically includes a game information storage area 32 suitable for storing two-dimensional maps, skin textures, animation programs, and virtually any other game information. Non-volatile memory 16c may be a hard disk, DVD-ROM, CD-ROM, Flash memory, Read Only Memory (ROM), EEPROM, or virtually any other non-volatile memory device. Volatile memory 16d is typically Random Access Memory (RAM), although virtually any type of volatile memory may be used.

User computing device 16 typically includes a user input device 16e, such as a keyboard, mouse, game controller, keypad, touch screen, microphone, or virtually any other user input device configured to by manipulated by a user to input a desired command. User computing device 16 also typically includes a display 16f on which computer animation, such as a computer game, may be displayed. User device 16 also typically includes a network interface 16g, which may be wireless or wired, by which the device may connect to network 17.

User computing device 16 typically is configured to execute an animation program 29, which is typically stored in non-volatile memory 16c. Animation program 29 is typically a computer game, although it will be appreciated that animation program 29 alternatively may be virtually any type of program configured to display computer animation. As used herein, the term “computer game” means any animation program in which a user may control the animation in real time, such as by controlling a character in the game. Computer games may be played on personal computers, gaming consoles, video arcade games, mobile computing devices, and virtually any other suitable computing device.

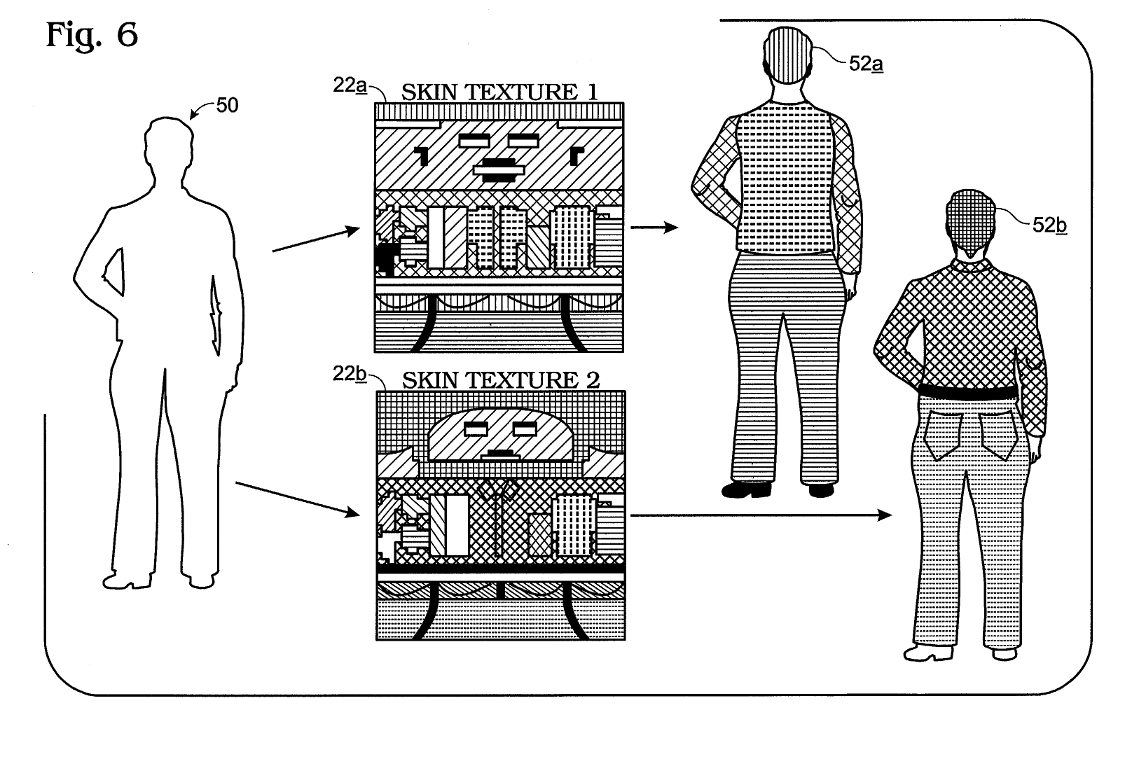

Animation program 29 typically includes a rendering engine 34. Rendering engine 34 is typically configured to receive two-dimensional map 24 with associated rendering information 30, and one or more skin textures 22, as input. As described in detail below, rendering engine 34 is configured to produce animated objects with different appearances, such as those shown at 20a-20d, by applying different skin textures, such as 22a-22d, to the same two-dimensional map 24. In addition, rendering engine 34 also may be configured to apply the same skin texture to a plurality of different two-dimensional maps, such as 24 and 50 (shown in FIG. 6), in order to render animated objects with a wide variety of appearances, such as facing forward and facing backward.

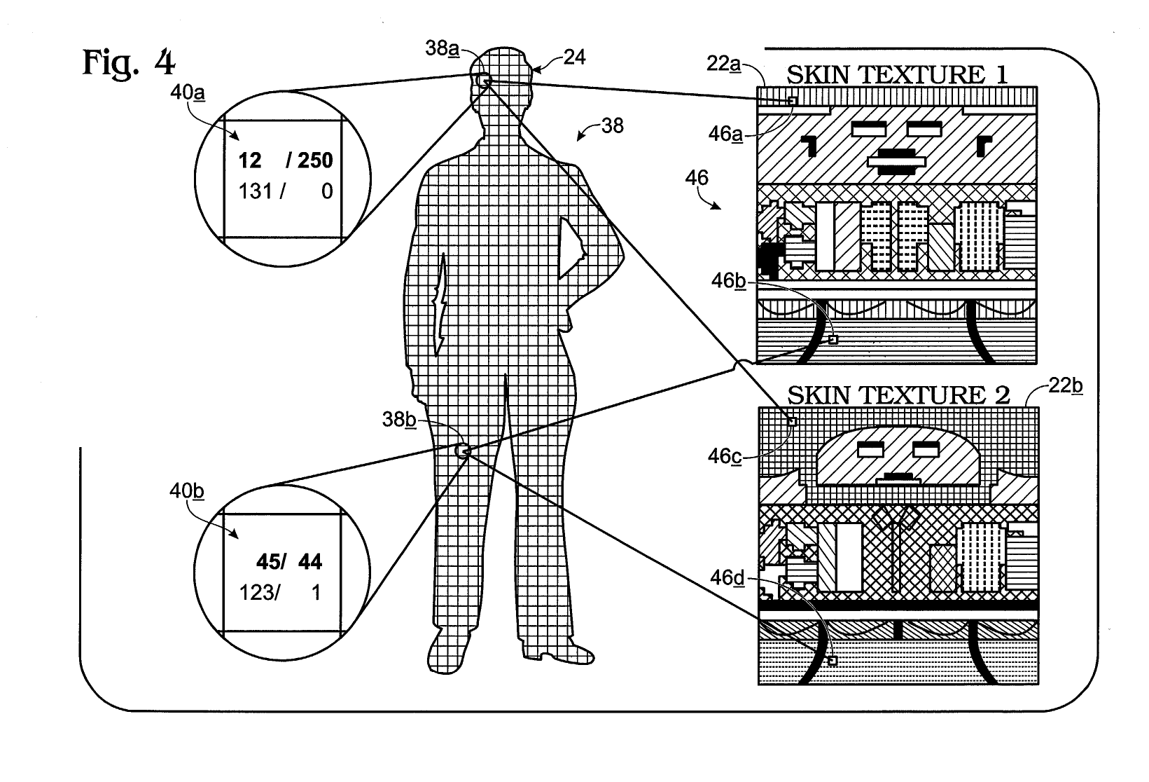

As shown in FIGS. 3 and 4, two-dimensional map 24 typically includes a plurality of map sectors 38, such as map sectors 38a and 38b. Each map sector 38 identifies a unique region on map 24. Typically, the map sectors are pixels, such that one map sector is one pixel of information. Each pixel of information typically has an associated position, color, brightness, and transparency. Of course, it will be appreciated that various other sizes and types of map sectors may be used, for example a plurality of pixels may form a map sector.

Map 24 also includes rendering information 30, which in turn is divided into rendering information subsets 40, such as 40a and 40b. Typically, each rendering information subset 40 is associated with a corresponding map sector 38. Each rendering information subset 40 includes a lookup pointer 43 such as 43a and 43b, which respectively correspond to rendering information subsets 40a and 40b. Each lookup pointer 43 typically includes a horizontal coordinate U and a vertical coordinate V, which collectively are configured to indicate a skin sector 46 of skin texture 22 that will be applied to a corresponding map sector 38, to thereby impart a desired color contained at the referenced skin sector 46 to the map sector 38. Alternatively, another type of lookup pointer suitable for indicating a particular portion of skin texture 22 may be used.

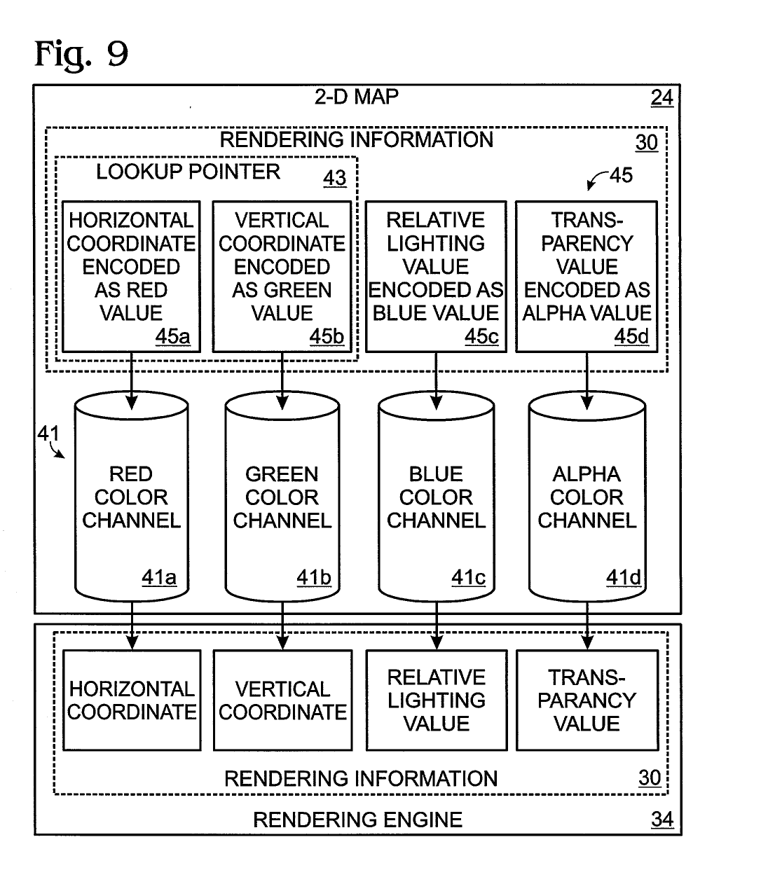

Each rendering information subset 40 typically further includes a lighting value L and a transparency value A to apply to the associated map sector 38, to thereby alter the lighting and transparency of the color at each map sector 38. As discussed below with reference to FIG. 9, the U, V, L, and A values are typically encoded as red, green, blue, and alpha values which are read by rendering engine 34 using red, green, blue and alpha color channels. Because the values encoded in the red, blue, green and alpha color channels are not R, G, B, and alpha color values that are used to directly adjust the red, blue, green, and alpha color characteristics of a pixel, rendering information 30 may be referred to herein as “non-color” rendering information, even though rendering information 30 may ultimately be used to obtain a color for the pixel by referencing an associated skin texture.

For each sector in map 24, rendering engine 34 typically is configured to (1) read the lookup pointer (i.e. horizontal coordinate U and vertical coordinate V) for the current map sector, (2) obtain the color of the skin sector referenced by the lookup pointer, (3) apply the color obtained from the skin sector to the current map sector, (4) read the lighting and transparency values for the current map sector, (5) adjust the lighting and transparency of the current map sector according to these values, and (6) display the current map sector according to the color, lighting and transparency values. In this manner, the map sectors may be used to collectively display an animated object 20. For instance, to apply skin texture 22a to map 24, rendering engine 34 may apply skin sectors 46a and 46b to corresponding map sectors 38a and 38b and so on for the other map sectors. In this manner, a two-dimensional map may be skinned to produce an animated object with a particular appearance. Rendering engine 34 may skin a two-dimensional map with different skin textures in order to render animated objects with different appearances.

Rendering engine 34 typically receives an identifier that indicates which skin texture should be applied to a particular two-dimensional map in order to render a particular animated object. Each rendering information subset includes a lookup pointer which points to skin sectors at the same relative position of different skin textures. For instance, rendering information subset 40a includes a horizontal coordinate U and vertical coordinate V that collectively point to skin sector 46a of skin texture 22a and also to skin sector 46c of skin texture 22b. Similarly, rendering information subset 40b includes a horizontal coordinate U and vertical coordinate V that collectively point to skin sector 46b of skin texture 22a and skin sector 46d of skin texture 22b.

Skin textures may be variously configured for compatibility with rendering engine 34. A skin texture may be an N×M array of skin sectors where N and M are integers that may or may not equal one another. In one embodiment, N and M equal the largest value a system's color channels are configured to transmit. In other embodiments, a skin texture with more or less detail may be used. When a less detailed skin texture is used, the rendering engine of the present invention typically interprets, such as by scaling, the lookup pointer to access the desired skin sector. For instance, if the lookup pointer includes a horizontal coordinate U where 0≦U<256 and the skin texture is only 64 skin sectors (256/4) in the horizontal direction, the rendering engine may divide U by 4 to determine the appropriate skin sector to access. Given a lookup pointer of a particular form, the rendering engine may perform virtually any interpretation suitable for accessing the appropriate skin sector.

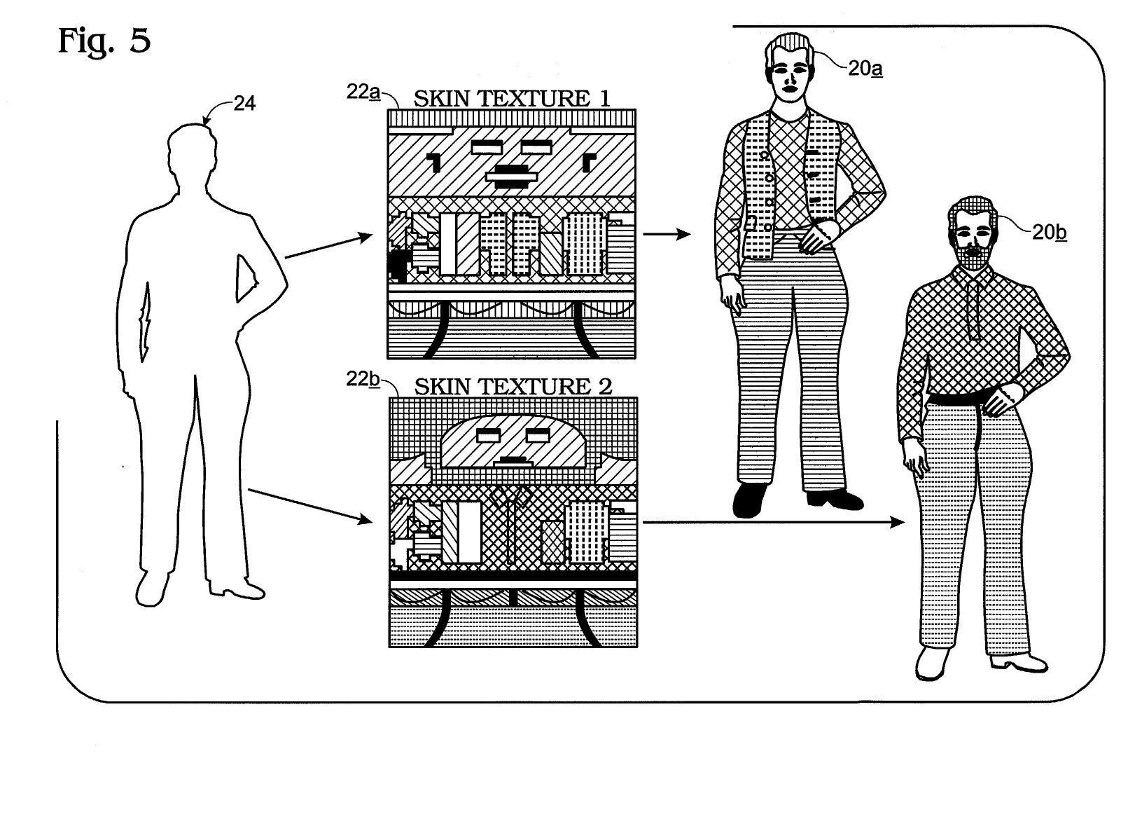

FIG. 5 shows that application of different skin textures to the same two-dimensional map may yield animated objects with different appearances. Applying skin texture 22a to two-dimensional map 24 results in animated object 20a, having a particular appearance. Similarly, applying skin texture 22b to two-dimensional map 24 results in animated object 20b, having a different appearance. In accordance with the present invention, virtually any animated object with the general form of two-dimensional map 24 may be rendered by applying a skin texture configured to produce the desired animated object.

FIG. 6, when compared to FIG. 5, shows that a two-dimensional map may be used to produce animated objects in a different position relative to animated objects produced with another two-dimensional map. For instance, the same skin textures applied to two-dimensional map 24 may be applied to two-dimensional map 50 in order to produce rear-facing animated objects 52a and 52b which are different than front-facing animated objects 20a and 20b.

A variety of two-dimensional maps may be utilized to produce animated objects in various positions and/or lighting conditions. The rendering engine may use a collection of such two-dimensional maps to simulate movement or other changes. For example, a series of such maps may be created in successive walking positions that may be consecutively displayed to simulate walking. A unique skin may be applied to a collection of two-dimensional maps to generate a unique set of animated objects. In this manner, for instance, a computer game may animate an entirely new character simply by applying a new skin texture to an existing collection of two-dimensional maps. Similarly, each character in a game may be given a new pose or action by adding a new two-dimensional map to an existing collection of two-dimensional maps.

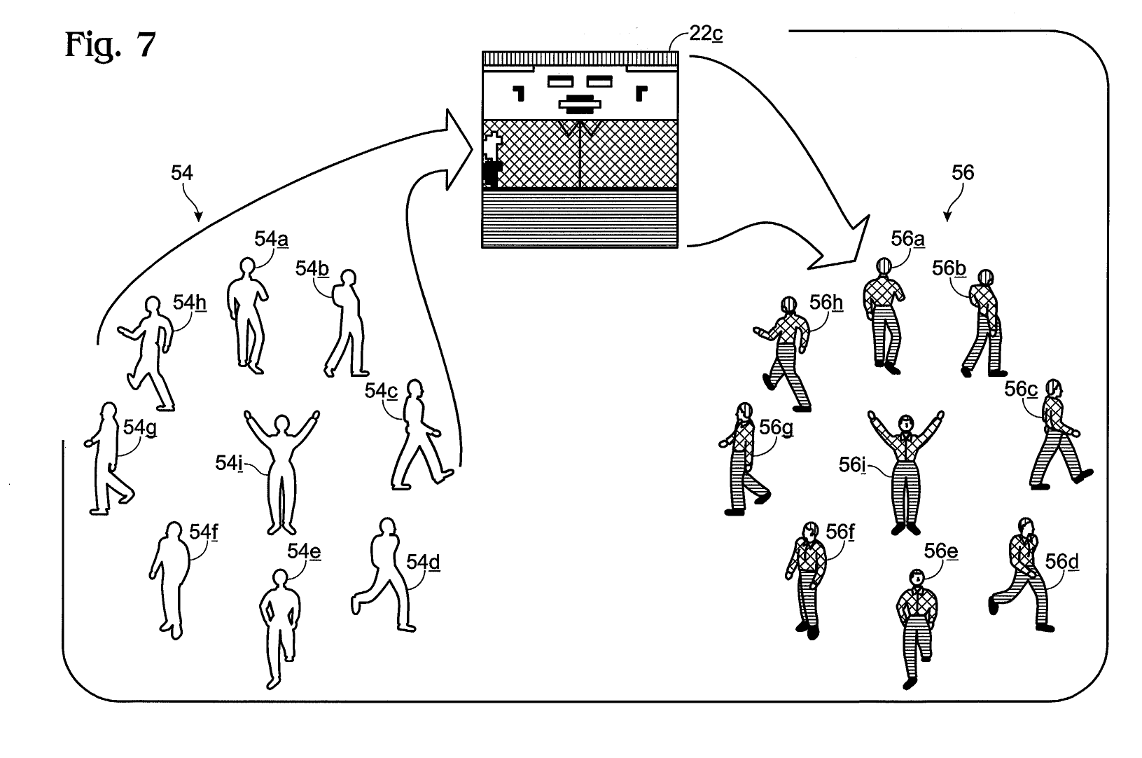

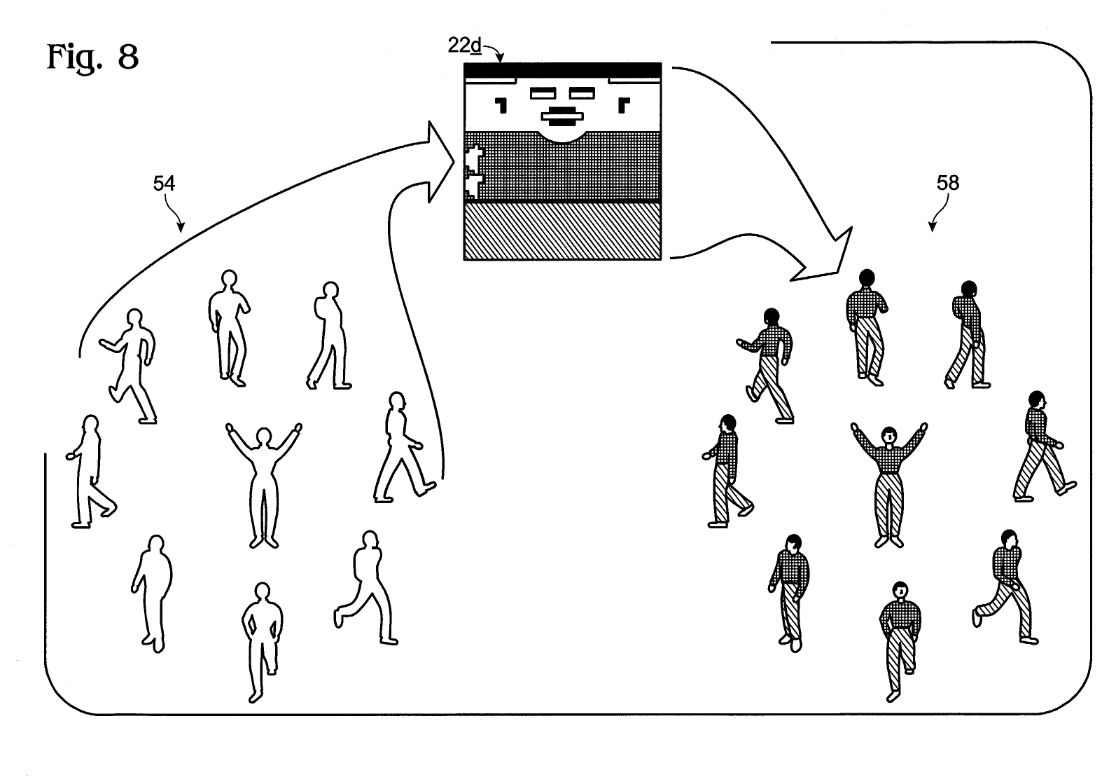

FIG. 7 shows skin texture 22c being applied to a collection 54 of two-dimensional maps 54a-54i to render a set 56 of animated objects 56a-56i. Collection 54 may include any number of two-dimensional maps. Each two-dimensional map typically represents a pose, action, or lighting condition, and the realism of an animated environment may usually be increased by adding additional two-dimensional maps to a collection. For instance, in a computer game, a character may be animated in a more realistic manner by increasing the number of poses and actions the character may execute by increasing the number of two-dimensional maps in the collection of two-dimensional maps corresponding to the character. As shown in FIG. 8, a different skin texture 22d may be applied to collection 54 to produce a set 58 of animated objects different from set 56.

Rendering engine 34 is typically configured to render animated objects more realistically by applying relative lighting values, such as the L value of rendering information subsets 40a and 40b. The relative lighting value is typically configured to make a lighting adjustment to the portion of an animated object corresponding to a particular map sector so that a rendered animated object will display with visually correct lighting. In one embodiment, the relative lighting value is subtracted from a value of 128 to yield a lighting adjustment value. The lighting adjustment value is typically a number with a relatively small absolute value. The lighting adjustment value may be applied to the color values obtained from a skin texture to adjust the color eventually displayed. For instance, subset 40a includes a relative lighting value equal to 131, and therefore rendering engine 34 may increase the relative lighting for the portion of an animated object corresponding to map sector 38a by 3 units in each displayed color. Similarly, the portion corresponding to map sector 38b may be decreased by 5 units. The lighting may be increased or decreased for any portion of an animated object. The method of determining the relative lighting values for a two-dimensional map is discussed below, with reference to FIG. 10.

Rendering engine 34 also is typically configured to render animated objects more realistically by applying transparency values, such as the A value of rendering information subsets 40a and 40b. The transparency value is typically configured to make an adjustment to the transparency of the portion of an animated object corresponding to a particular map sector. For instance, subset 40a includes a transparency value equal to 0 on a scale from 0 to 255. Therefore rendering engine 34 may display the portion of an animated object corresponding to map sector 38a without transparency. Similarly, the portion corresponding to map sector 40 may be displayed with a slight level of transparency. The transparency may be increased or decreased for any portion of an animated object. While typically the transparency values are encoded into map 24, alternatively transparency values may be included in the skin textures so that the transparency of an animated object is dependent on the skin texture used to render the animated object.

FIG. 9 shows rendering engine 34 receiving rendering information 30 via color channels 41, such as 41a-41d. Rendering engine 34 typically is configured to read color information via color channels in which the color information is stored and transmitted. Each color channel typically corresponds to a single color. While a pixel on a display may appear to be a single color, the displayed color typically is a combination of constituent colors (often red, green, and blue). Each constituent color is determined by a color value transmitted via its color channel. Rendering engine 34 typically receives rendering information encoded as color information via such color channels. For instance, rendering engine 34 may be configured to receive color values 45, such as 45a-45d, typically ranging from 0 to 255, via each of the respective color channels. In accordance with one embodiment of the present invention, color values 45, act as a carrier for rendering information 30. In this manner, color values 45 do not, in the traditional sense, directly correspond to the color eventually displayed, but rather act as rendering values that may be used as described above with reference to FIGS. 1-8.

As discussed above, rendering information 30 may be transmitted in rendering information subsets 40, such as 40a and 40b. In this manner, the U, V, L, and A values for each subset are respectively encoded as Red, Green, Blue, and Alpha color values, which may be transmitted as described above. It should be understood that rendering information 30 may be encoded in various ways and the above example is only one possibility. Furthermore, it should be understood that alternative or additional rendering information may be encoded and that alternative or additional color or other values may be used to transmit the rendering information.

FIG. 10 depicts the creation of two-dimensional map 24. First, a three-dimensional model 60 is created. Typically, the three-dimensional model is created with map generation system 26 on developer computer 12. After three-dimensional model 60 is created, typically two separate renders, a lookup render 63 and a lighting render 65, are performed in a virtual three-dimensional space, and information from both renders is combined into a flattened two-dimensional map 24 via a combination render 67 and a flatten render 69. Rendering in a virtual three-dimensional space typically requires a powerful computing platform and therefore is suited for developer computer 12. Performing the complicated rendering calculations on developer computer 12 alleviates user computing device 16 from having to perform the complex calculations. Therefore, user computing device 16 does not have to be configured with a powerful GPU. Because the complex three-dimensional rendering is performed by developer computer 12, user computing device 16 may real-time render realistic animated objects that appear three-dimensional without actually performing three-dimensional rendering calculations.

Lookup render 63 encodes skin texture lookup information into three-dimensional model 60. To accomplish lookup render 63, the three-dimensional model is typically skinned with a unity texture 62 to produce a UV model 64. Unity texture 62 is a specially configured skin texture that typically includes a plurality of skin sectors, each of which is typically characterized by a color value different from the other skin sectors. In one embodiment, the unity texture 62 is pure red (red=255) along the vertical axis on the right side of the unity texture (U=255, 0≦V<256) with the value of red decreasing along the horizontal axis as U approaches zero; and the unity texture 62 is pure green (green=255) along the horizontal axis at the top of the unity texture (0≦U<256, V=255) with the value of green decreasing along the vertical axis as V approaches zero. In this manner, for each unity-texture sector, the red value equals the horizontal coordinate of the unity-texture sector and the green value equals the vertical coordinate of the unity-texture sector. When model 60 is skinned with unity texture 62, each sector of the resulting three-dimensional UV model 64 is characterized by a color value different from that of nearly every other sector of UV model 64. The color values of each sector of UV model 64 point to a corresponding skin sector, such as those from skin textures 22a-22d. Lookup render 63 is typically performed with no ambient, diffuse or directional lighting, and the skin texture is set to be 100% self-illuminating so that it radiates its own color.

Lighting render 65 infuses relative lighting information into three-dimensional model 60 to render an L model 68. Three-dimensional model 60 is skinned with a flat gray skin texture 66, such as a skin texture with red, green, and blue color values each equal to 128. Lighting render 65 is typically performed with only directional lighting enabled. The lighting is usually positioned corresponding to where directional lighting will be positioned in the animated environment eventually displayed by computing device 16. The directional lighting may increase or decrease-the color values associated with a particular model-sector because of the model-sector's orientation relative to the lighting. In one embodiment, the color values are modified for each model-sector by the sum of the dot products of that model-sector's normal vector and the directional lighting vectors at that sector. If the directional lighting is pure white, each of the color values, such as red, green, and blue, will typically be modified by the same amount. If the directional lighting is not pure white, the color values may be modified independent of one another. The modified color values, which are typically equal to one another because of the use of white directional lighting, may be stored as blue color values in the resulting three-dimensional L model 68. In this manner, the blue color value contains the relative lighting information for all colors as they will eventually be rendered in real time.

The UV model and L model may be combined, with or without transparency information, to form a UVLA model 70 via a combination render 67. UVLA model 70 typically includes skin texture lookup information in its color values, such as its red and green color values. UVLA model 70 also typically includes relative lighting information in another of its color values, such as its blue color value, and transparency information in yet another of its color values, such as its alpha color value. The developer computer typically flattens three-dimensional UVLA model 70 into two-dimensional map 24 via flatten render 69. As such, each two-dimensional map 24 is a two-dimensional projection of a particular orientation of UVLA model 70. UVLA model 70 may be flattened relative to different perspectives to create different two-dimensional maps. The skin texture lookup information, relative lighting information, and transparency information is usually included in two-dimensional map 24 as rendering information 30. As described above, the rendering information is typically stored as color values associated with each map sector. The method described above may be repeated to produce one or more two-dimensional map collections, such as two-dimensional map collection 54.

As described above, two-dimensional map 24 typically includes lookup, lighting, and transparency (UVLA) rendering information 30. However, it should be understood that two-dimensional map 24 may include any sub combination of the above described rendering information as well as any other rendering information, alone or in combination with UVLA or other rendering information, useful in producing desirable animated objects.

User computing devices such as user computing device 16 may use two-dimensional maps, in conjunction with one or more skin textures, to render in real time animated objects. Real-time rendering allows an animated object to be rendered in response to user input or computer control. For example, based on user input a computer game may render an animated object such as animated object 22a as described above. Because this two-dimensional rendering is not calculation intensive, it may be performed in real time by computing devices without powerful calculation capabilities. In response to additional user input, such as input directing a computer game character to turn around, rendering engine 34 may display a different animated object, such as animated object 52a. In this manner, new animated objects may be consecutively displayed in response to user input. Such display may create the illusion of realistic movement and action, which typically increases game play value.

As shown in FIG. 11, system 10 may further include a plurality of user computing devices 16, 16′, and 16″ linked via network 17 to each other and to developer computer 12 and third party computer 14. Such an arrangement may be used to play network games. User computing devices 16, 16′, and 16″ are typically configured to render, in real time, animated objects as described above. Each of user computing devices 16, 16′, and 16″ may render animated objects in response to user input entered on that device or user input entered on another device. In this manner, a user on one device, such as device 16, may control a character 86, while a user on another device, such as 16′, controls another character 88. Both characters may be displayed from the same or different perspectives on both devices as well as on other computing devices, such as 16″. Furthermore, the characters may be displayed with the same or different skins on each of the various networked user computing devices.

User computing devices such as 16, 16′, and 16″ typically are linked to network 17 via a network interface 16g. Network interface 16g is typically configured to facilitate communication between at least two of the plurality of computing devices. Network interface 16g may be a modem, network interface card, wireless networking card, cellular transceiver, or virtually any other suitable mechanism. The network interface may facilitate communication via one or more of a local area network, a wide area network, a cellular network, a wireless data transmission network, or virtually any other suitable network. In one embodiment, the network interface facilitates data transmission via the Internet. In addition to transmitting user input and other game information, the network interface may transmit two-dimensional maps such as 24, skin textures 22, executable files such as animation program 29, or virtually any other suitable data. In this manner, computing devices may receive, e.g. download, new or updated two-dimensional maps, skin textures, animation programs, or other data, from developer computer 12, third party computer 14, or other computing devices.

Third party computer 14 may be configured to facilitate network gaming. For example, third party computer 14 may be configured to send and receive game information between user computing devices such as 16, 16′, and 16″. The gaming information may include user input entered into the respective computing devices, such as input controlling the movement and actions of a game character. Third party computer may also be configured with a central repository at which skin-textures and other game information may be stored and transmitted (e.g. uploaded from third party computer 14 and downloaded to user computing device 16) to user computing devices via network 17. Such game information may include level maps, sounds, music, and virtually any other information useful in improving game play.

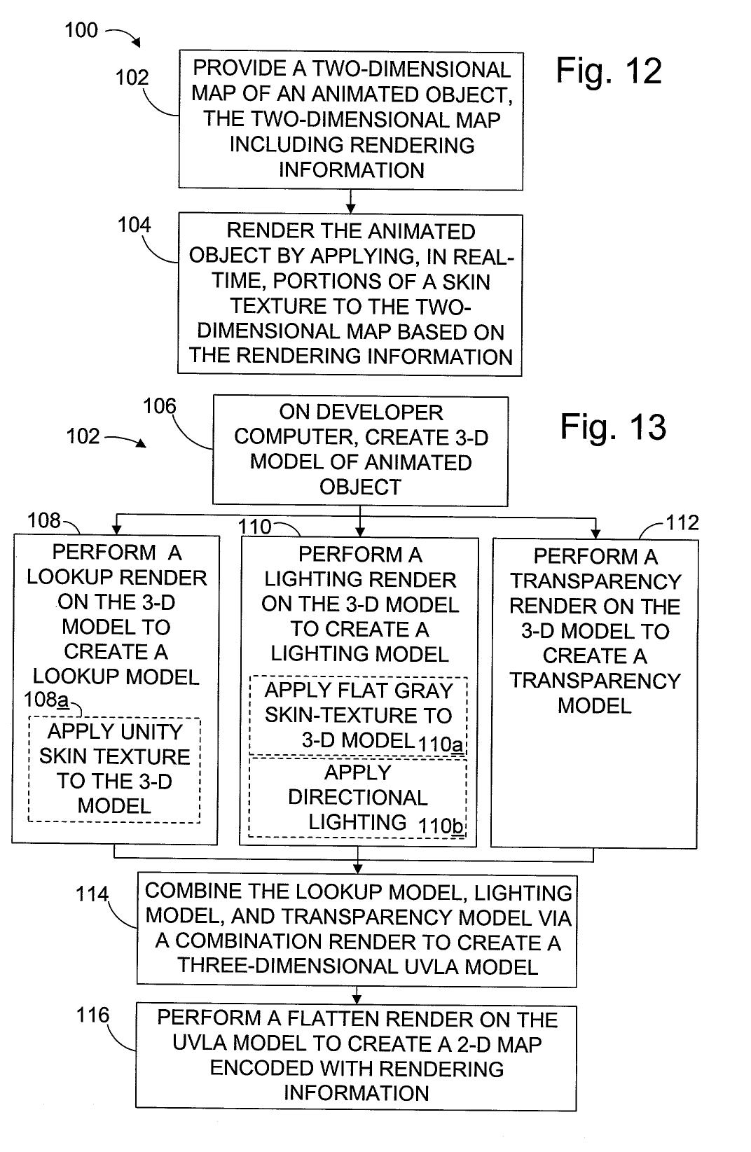

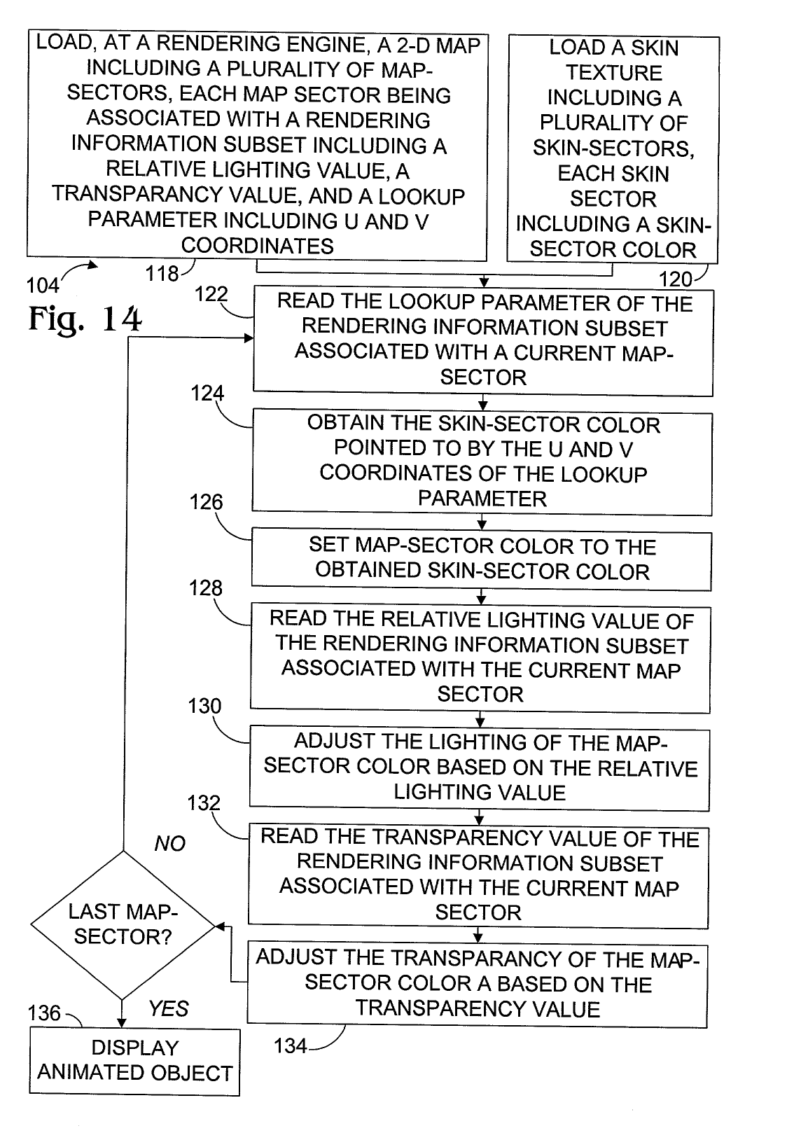

FIG. 12 shows, generally at 100, a computer animation method in accordance with one embodiment of the present invention. Method 100 typically includes, at 102, providing a two-dimensional map of an animated object, the two-dimensional map including rendering information 30, as described above. At 104, the method further includes rendering the animated object by applying, in real time, portions of a skin texture to the two-dimensional map based on the rendering information. An exemplary method of performing step 102 is provided below with reference to FIG. 13. Similarly, an exemplary method of performing step 104 is provided below with reference to FIG. 14.

FIG. 13 shows one exemplary method of performing step 102 in accordance with one embodiment of the present invention. Step 102 typically includes, at 106, creating a three-dimensional model of an animated object on a developer computer. The three-dimensional model is a virtual three-dimensional construction defined by a collection of data. The three-dimensional model may be in the form of a game character or other animated object such as a vehicle, personal effect, landscaping element, or virtually any other item suitable for inclusion in an animated environment. The collection of data includes information describing the three-dimensional model's shape in three-dimensions so that the model may be virtually rotated and perceived from various perspectives. The three-dimensional model may also include realistic surface details such as folds in clothing that may be shaded differently by applying directional lighting from different locations and angles. As discussed above, the three-dimensional model may be created using a map generation system. Typically the three-dimensional model will have a single texture sheet assigned to the entire model. In other words, a single skin texture may completely skin the three-dimensional model.

The method typically further includes, at 108, performing a lookup render on the three-dimensional model to create a lookup model. The lookup render encodes information into the three-dimensional map that points to specific locations on skin textures. As discussed above, such information is typically encoded as a lookup pointer including U and V coordinates. The U and V coordinates are typically defined, at each sector of the lookup model, by color values found at that sector. The sector is usually a single pixel of information. For instance, a pixel may have a red value R and a green value G. The R and G values typically act as carries for the lookup pointer (U and V values), as described above. The U and V values may be used as a horizontal-vertical coordinate pair to locate a specific skin sector on a skin texture. Of course U and V coordinates may be encoded as virtually any color corresponding to an existing color channel, while V may be encoded as a color corresponding to any other color channel. Also, non-rectangular coordinate systems may be used. For instance, thermometer-type coordinates may be used in which each sector of a skin texture is located by a single value.

Lookup information may be encoded into a three-dimensional map using several different methods. One such method, as shown at 108a, includes applying a unity skin texture to the three-dimensional model. As described above and shown at 62 of FIG. 10, a unity skin texture is a specially configured skin texture in which one color value increases along one axis while another color value increases along another axis. A three-dimensional model may be skinned with a unity texture, which will typically produce a three-dimensional model with a unique color at every sector of the model's skin. Skinning with the unity texture is typically performed by applying the skin sectors of the unity texture to the model so that each skin sector is only found at one region of the model. The applied color may be sampled anywhere on the model to obtain color values that may be used to lookup a sector of a skin texture as described above.

The method typically further includes, at 110, performing a lighting render on the three-dimensional model to create a lighting model. The lighting render encodes information into the three-dimensional map that may adjust the color of the map to simulate actual lighting conditions. As discussed above, such information is typically encoded as a relative lighting value. The relative lighting value is typically defined, at each sector of the lighting model, by a color value found at that sector. The sector is usually a single pixel of information. For instance, a pixel may have a blue value B. The B value typically acts as a carrier for a relative lighting value L as described above. The L value may be used to adjust any of the color values used to eventually display animated objects. Of course, the relative lighting value may be encoded as virtually any color corresponding to an existing color channel.

Relative lighting information is typically encoded into a three-dimensional map by initially applying a flat gray skin texture, as shown at 66 of FIG. 10, to the three-dimensional model, as shown at 110a. The flat gray skin texture typically is configured so that the value for every color of the skin texture is equal to one another, and each is set near the middle of its range. For instance, in a 1 byte (8 bit) system where each color may be one of 256 values, each color is typically set to 128. For an RGB system, the flat gray skin texture may be configured so that for each skin sector, or pixel, R=G=B=128.

As shown at 110b the method typically includes applying directional light to the three-dimensional model skinned with the flat gray skin texture to determine how such lighting affects the coloring of the three-dimensional model. The model is typically virtually situated relative to directional lighting similar to how animated objects based on the three-dimensional model will be situated in an animated environment. For instance, if a game character will be facing forward with light shining on the character's right side in a computer game, the three-dimensional model used to create the game character will be virtually situated facing forward with light shining on the character's right side during the lighting render. In this manner, several different lighting renders under different lighting conditions may be performed to create several different two-dimensional maps, each of which may be used to render animated objects with different lighting conditions.

Directional lighting may cause some areas of the three-dimensional model's skin to brighten while other areas darken. Of course, some areas may be unaffected by the light. Pure white directional lighting typically causes each of the color values for a sector or pixel to change by the same amount. For instance, a particular sector exposed to the directional lighting may have color values R=G=B=123. A single value may be used to represent the adjustment for each color because the adjustment is the same for each color. The relative lighting value is typically calculated for each sector of the three-dimensional model by summing the dot products of that sector's normal vector and the directional lighting vectors at that sector. For instance, if a particular sector has a normal vector n, and a single directional lighting vector d is shining on that sector, the relative lighting value at that sector would be calculated via the vector operation L=n dot d. Of course, virtually any other method may be used to calculate a relative lighting value for a given sector. After all of the relative lighting calculations are made, the results are typically stored as color values so that the lighting model includes a relative lighting value encoded as a color value at each sector of the lighting model.

The method typically further includes, at 112, performing a transparency render to create a transparency model. The transparency render encodes information into the three-dimensional map that may adjust the transparency of the map. The transparency information is typically encoded as an alpha value. The transparency render may be bypassed completely, and transparency information may be added to the two-dimensional map after a flatten render described below. Also, transparency information may be included in skin textures so that the transparency of an animated object depends on the skin texture used to render that animated object.

The method typically further includes, at 114, combining the lookup model, the lighting model, and the transparency model (if a transparency render was executed) via a combination render to create a three-dimensional UVLA model. The UVLA model includes the lookup pointer encoded during the lookup render, the relative lighting information encoded during the lighting render, and the transparency information encoded during the transparency render. The UVLA model is three-dimensional, and therefore, may be viewed from various perspectives.

The method typically further includes, at 116, performing a flatten render on the UVLA model to create a two-dimensional map of an animated object encoded with rendering information. The two-dimensional map includes all of the rendering information of the above described three-dimensional UVLA model but only from a single perspective. Because all of the three-dimensional information is removed during the flatten render, the two-dimensional map may be stored in a substantially smaller space than the associated three-dimensional model.

The flatten render is typically accomplished by positioning the three-dimensional UVLA model in a perspective corresponding to a perspective an animated object will be viewed from after rendering the animated object. A two-dimensional projection of the three-dimensional model is then obtained from that perspective. If several views are desired, the perspective may be changed to correspond to the various views and a two-dimensional projection may be obtained from each respective perspective. In this manner, a character in the same position and lighting conditions may be viewed from several angles. Of course, each such angle results in a separate two-dimensional map.

Two-dimensional maps may be stored on a storage medium for distribution. Two-dimensional maps may also be distributed via network transmission. Typically, two-dimensional maps are distributed as a component of an animation program such as a computer game. The distribution mechanism may be selected to accommodate various types of receiving devices. For instance, if the two-dimensional maps will eventually be used to render animated objects on a mobile computing device such as a wireless telephone, the maps may be distributed via a wireless network.

FIG. 14 shows one exemplary method of accomplishing step 104 in accordance with one embodiment of the present invention. Step 104 typically includes, at 118, loading, at a rendering engine, a two-dimensional map including a plurality of map sectors, each map sector being associated with a rendering information subset including a relative lighting value, a transparency value, and a lookup pointer including U and V coordinates. The rendering engine of an animation program running on a user computing device typically loads two-dimensional maps from non-volatile long term storage into volatile memory during rendering. As described above, each map sector typically is a single pixel or alternatively a group of pixels. The relative lighting value, transparency value, and lookup pointer of each rendering information subset is typically encoded as color information. Color information may be transmitted via color channels and as such, rendering information encoded as color information may also be transmitted via color channels, as described above.

The method typically further includes, at 120, loading, at the rendering engine, a skin texture including a plurality of skin sectors, each skin sector including a skin sector color. The rendering engine of an animation program typically loads skin textures from non-volatile long term storage into volatile memory during rendering. As described above, the rendering engine may, upon instruction, load a particular skin texture selected from a variety of skin textures in order to render an animated object with a particular appearance. The animation program, of which the rendering engine is typically a component, usually receives an identifier that indicates the skin texture that should be applied to a particular two-dimensional map in a given real-time render.

As shown at 122, the method further includes reading the lookup pointer of the rendering information subset associated with a current map sector. As described above, the lookup pointer is typically encoded as color values, and the rendering engine reads the lookup pointer via color channels. For instance, when the red and green color channels are configured to transmit the lookup pointer, a map sector where R=12 and G=250 yields a lookup pointer in which U=12 and V=250. The rendering engine typically reads these values for each map sector.

The method further includes, at 124, obtaining the skin sector color pointed to by the U and V coordinates of the lookup pointer. The U and V coordinates point to a particular sector of a skin texture. The rendering engine typically samples the color of that sector so that it may be applied to the two-dimensional map. The skin sector color usually is a combination of several different color values such as red, green, blue, and alpha color values.

As shown at 126, the method further includes setting the map sector color to the obtained skin sector color. In this manner, each map sector may be colored the skin sector color of the skin sector pointed to by the map sector's associated rendering information subset. The color values may be used to access a color from the skin texture that may be completely different from the color that the rendering information subset would be used to produce using traditional methods. By repeating this step for every map sector, the two-dimensional map is skinned with colors from a skin texture according to the lookup pointers of the rendering information subsets associated with the map sectors.

The method further includes, at 128, reading the relative lighting value of the rendering information subset associated with the current map sector. As described above, the relative lighting value is typically encoded as a color value, and the rendering engine reads the relative lighting value via a color channel. For instance, when the blue color channel is configured to transmit the relative lighting value, a map sector where B=131 yields a relative lighting value in which L=131. The rendering engine typically reads this value for each map sector.

As shown at 130, the method further includes adjusting the lighting of the map sector color based on the relative lighting value. In this manner, the map sector color of each map sector may be adjusted to simulate actual lighting conditions. The adjustment is typically made by subtracting 128 (when using a 1 byte system) from the relative lighting value to obtain a delta value. The delta value is typically added to each of the color channels of the map sector, which lightens or darkens the map sector color. The lighting responsible for the adjustment is typically the directional lighting applied during the lighting render on the developer computer. However, when rendered on a user computing device, the lighting may appear to originate from the animated environment.

The method further includes, at 132, reading the transparency value of the rendering information subset associated with the current map sector. As described above, the transparency value is typically encoded as a color value, and the rendering engine reads the transparency value via a color channel. For instance, when the alpha color channel is configured to transmit the transparency value, a map sector where alpha=0 yields a transparency value in which A=0. The rendering engine typically reads this value for each map sector.

As shown at 134, the method further includes adjusting the transparency of the map sector color based on the transparency value. In this manner, the map sector color of each map sector may be adjusted to be completely transparent, completely opaque, or an incremental level of transparency therebetween. Such transparency may be used for edge anti-alias alpha blending, for instance.

A map sector color is typically obtained and adjusted as described above for each map sector. This may be accomplished sector-by-sector or in groups of sectors so that some sectors are completely rendered before others. Alternatively, an entire two-dimensional map, or portion thereof, may be colored and then adjusted for lighting and transparency.

The two-dimensional map typically includes lookup, lighting, and transparency information. Alternatively, the two-dimensional map may include a sub-combination of this information as well as additional information. For instance, if during map generation, as described above, the lighting render or transparency render is not performed, the resulting two-dimensional map will not have the respective lighting or transparency information. Similarly, a render may be performed to include additional information into the UVLA model, and the resulting two-dimensional map would include such information.

As shown at 136, the method may further include displaying the animated object. Animated objects rendered in accordance with the methods described above may be displayed on virtually any type of display. Often times, several animated objects will be consecutively displayed to simulate movement or other action. Furthermore, the movements and actions of animated objects may be controlled in real time by user input. Several users may individually or jointly control animated objects on the same or different user computing devices. Several animated objects may appear on a display at the same time, some of which may be controlled by users while others may be controlled by a user computing device.

The above described embodiments provide for the rendering of animated objects. Such rendering may be performed on computing devices lacking a powerful GPU. Furthermore, because of their relatively small size, many skin textures and two-dimensional maps may be stored on devices with small storage capabilities.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

We claim:

1. A computer animation method, comprising:
providing a two-dimensional map of an animated object, the two-dimensional map including rendering information; and
rendering the animated object by applying, in real time, portions of a skin texture to the two-dimensional map based on the rendering information.

2. The method of claim 1, wherein the animated object is a computer game character.

3. The method of claim 1, wherein the skin texture is one of a plurality of skin textures, each skin texture configured to produce a corresponding animated object in an animated environment.

4. The method of claim 3, wherein the animated environment is a computer game environment.

5. The method of claim 1, wherein the skin texture includes a plurality of skin sectors.

6. The method of claim 5, wherein each skin sector is addressable via one or more coordinates.

7. The method of claim 6, wherein each skin sector is addressable via a horizontal-vertical coordinate pair.

8. The method of claim 1, wherein the rendering information includes a lookup pointer linking the two-dimensional map to the skin texture.

9. The method of claim 8, wherein the map includes one or more color channels configured to transmit the lookup pointer.

10. The method of claim 8, wherein the lookup pointer corresponds to a skin sector.

11. The method of claim 10, wherein the lookup pointer includes a horizontal coordinate.

12. The method of claim 10, wherein the lookup pointer includes a vertical coordinate.

13. The method of claim 10, wherein the lookup pointer includes a horizontal-vertical coordinate pair.

14. The method of claim 8, wherein the step of rendering is accomplished at least in part by obtaining from the skin texture a color pointed to by the lookup pointer, and skinning a portion of the two-dimensional map with that color.

15. The method of claim 1, wherein the rendering information includes a relative lighting value.

16. The method of claim 15, wherein the map includes a color channel configured to transmit the relative lighting value.

17. The method of claim 15, wherein the step of rendering is accomplished at least in part by adjusting lighting on a portion of the animated object based on the relative lighting value.

18. The method of claim 1, wherein the rendering information includes a transparency value.

19. The method of claim 18, wherein the map includes a color channel configured to transmit the transparency value.

20. The method of claim 18, wherein the step of rendering is accomplished at least in part by adjusting transparency on a portion of the animated object based on the transparency value.

21. The method of claim 1, wherein the two-dimensional map includes a plurality of map sectors, each map sector being associated with a corresponding subset of rendering information.

22. The method of claim 1, wherein the two-dimensional map is based on a three-dimensional model.

23. The method of claim 22, wherein the two-dimensional map is a two-dimensional projection of the three-dimensional model.

24. The method of claim 1, wherein the two-dimensional map is one of a plurality of two-dimensional maps, the plurality of two-dimensional maps constituting a map collection configured to facilitate rendering at least one set of animated objects.

25. The method of claim 1, wherein the step of providing is accomplished at least in part by:
creating a three-dimensional model of the animated object;
performing a lookup render on the three-dimensional model to create a lookup model;
performing a lighting render on the three-dimensional model to create a lighting model;
combining the lookup model and the lighting model via a combination render to create a three-dimensional UVLA model; and
performing a flatten render on the UVLA model to create the two-dimensional map encoded with rendering information.

26. A computer animation method, comprising:
rendering, in real time, a first animated object by applying portions of a first skin texture to a two-dimensional map of the animated object; and
reusing the two-dimensional map to render, in real time, a second animated object by applying portions of a second skin texture to the two-dimensional map.

27. The method of claim 26, wherein portions of the first and second skin textures are applied to the two-dimensional map based on the rendering information of the two-dimensional map.

28. The method of claim 26, wherein the step of rendering is accomplished at least in part by obtaining from the first skin texture a color pointed to by a lookup pointer, and skinning a portion of the two-dimensional map with that color.

29. The method of claim 26, wherein the step of rendering is accomplished at least in part by adjusting lighting on a portion of the animated object based on a relative lighting value.

30. The method of claim 26, wherein the step of rendering is accomplished at least in part by adjusting transparency on a portion of the animated object based on a transparency value.

31. A computer animation method, comprising:
transmitting non-color rendering information via a color channel, wherein the non-color rendering information is encoded as color information; and
rendering an animated object based on the non-color rendering information.

32. The method of claim 31, wherein the non-color rendering information includes a lookup pointer linking a two-dimensional map of the animated object to at least one skin texture.

33. The method of claim 32, wherein the lookup pointer includes a horizontal-vertical coordinate pair corresponding to a skin sector of the at least one skin texture.

34. A computer game, comprising:
a two-dimensional map of at least one animated object, the two-dimensional map including rendering information;
at least one skin texture; and
a rendering engine configured to render an animated object corresponding to the at least one skin texture via applying the at least one skin texture to the two-dimensional map based on the rendering information.

35. The game of claim 34, wherein the rendering information includes a lookup pointer linking the two-dimensional map to the skin texture.

36. The game of claim 35, wherein the map includes one or more color channels configured to transmit the lookup pointer.

37. The game of claim 35, wherein the lookup pointer includes a horizontal-vertical coordinate pair corresponding to a skin sector of the skin texture.

38. The game of claim 34, wherein the rendering information includes a relative lighting value.

39. The game of claim 38, wherein the map includes a color channel configured to transmit the relative lighting value.

40. The game of claim 34, wherein the rendering information includes a transparency value.

41. The game of claim 40, wherein the map includes a color channel configured to transmit the transparency value.

42. A computing device comprising:
memory configured to store:
(a) a two-dimensional map of an animated object, the two-dimensional map including rendering information,
(b) at least one skin texture, and
(c) instructions that, when executed, result in the computing device having the capability of rendering the animated object by applying, in real time, portions of the at least one skin texture to the two-dimensional map based on the rendering information; and
a processor configured to execute the instructions.

43. The computing device of claim 42, wherein the computing devices is a laptop computer, a desktop computer, an embedded computer, a gaming console, a mobile telephone, a personal digital assistant, or a mobile gaming device.

44. The computing device of claim 42, further comprising a network interface configured to transmit game information.

45. The computing device of claim 44, wherein transmitted game information includes a two-dimensional map received from another computing device, wherein the two-dimensional map received from the other computing device is used to real-time render an animated object.

46. A storage medium including instructions that, when executed, result in a computing device having the capability of:
loading a two-dimensional map of an animated object, the two-dimensional map including rendering information; and
rendering the animated object by applying, in real time, portions of a skin texture to the two-dimensional map based on the rendering information.

47. A method of generating a two-dimensional map configured to facilitate rendering an animated object, comprising:
creating a three-dimensional model of an animated object;
performing a lookup render on the three-dimensional model to create a lookup model;
performing a lighting render on the three-dimensional model to create a lighting model;
combining the lookup model and the lighting model via a combination render to create a three-dimensional UVLA model; and
performing a flatten render on the UVLA model to create a two-dimensional map encoded with rendering information.

48. A computer animation system, comprising:
a computer network; and
at least one user computing device connectable to the computer network and configured to download, via the computer network, skin textures configured for application to a two-dimensional map of an animated object in order to render, on the user computing device, the animated object.

49. The computer system of claim 48, further comprising:
a third party computer configured to store skin textures in a repository and to upload one or more of the skin textures, via the computer network, to the user computing device.

50. The computer system of claim 49, wherein the third party computer is configured to receive, via the computer network, game information from a first user computing device and send, via the computer network, the game information to a second user computing device, wherein the game information is used to render an animated object.

51. The computer system of claim 48, further comprising:
a developer computer configured to upload the skin textures, via the computer network, to the user computing device.

52. The computer system of claim 51, wherein the developer computer is configured to create the two-dimensional map and upload the two-dimensional map, via the computer network, to the user computing device.
